(19) United States
(12) Patent Application Publication
(10) Pub. No.: US 2022/0194590 A1
(43) Pub. Date: Jun. 23, 2022

(54) COPPER PLATED TOUCH SURFACES

(71) Applicant: B/E Aerospace, Inc., Winston-Salem, NC (US)

(72) Inventor: Samuel Foster, Milton Keynes (GB)

(73) Assignee: B/E Aerospace, Inc., Winston-Salem, NC (US)

(21) Appl. No.: 17/126,024

(22) Filed: Dec. 18, 2020

(51) Int. Cl. B64D 11/04; G06F 3/041; A01N 59/20; A01N 25/34

(52) U.S. Cl. CPC B64D 11/04; A01N 25/34; A01N 59/20; G06F 3/041

(57) ABSTRACT

An aircraft including a cabin galley having a plurality of touch surfaces, wherein at least one of the touch surfaces includes a copper material for reducing a bacterial or viral count on the surface and reducing the risk of infection transmission.

### BACKGROUND

### Technological Field

The present disclosure relates to an aircraft galley, and more particularly to an aircraft galley having copper plated touch surfaces to prevent bacterial and viral spread.

### Description of Related Art

The COVID-19 virus and other common viruses can be transmitted by touching common surfaces and leaving behind some amount of saliva with viral particles. Due to the heightened need for aircraft and other high density vehicles to have additional protective measures to prevent or limit infection especially on high frequency touch points such as handles, knobs, latches and catches, to prevent cross contamination and the spread of the virus between passengers and cabin crew.

With a new global reality and increased risk in place a need has arisen for effective passive counter to viral contamination without any additional chemical cleaning, while providing simple installation and replacement, and potential for retrofitting to currently in-service aircraft. There also remains a need in the art for such systems, methods, and components that are economically viable. The present disclosure may provide a solution for at least one of these remaining challenges.

### SUMMARY OF THE INVENTION

An aircraft including a cabin galley having a plurality of touch surfaces is disclosed. At least one of the touch surfaces includes a copper material and a user facing surface. The at least one touch surface can be connected to a touch-screen interface. The touch screen interface can be copper plated. The touch surface can include a counter top or a drawer handle. The copper plating can be transparent.

A majority of the touch surfaces can be copper plated. A portion of the touch surfaces or touch surface does not include copper. A majority of the touch surfaces of the cabin galley can include a copper material. A majority of handles within the galley can include a copper surface. The copper material includes a non-copper overlay, wherein the non-copper overlay is opaque. The non-copper overlay can include a non-copper dye. The non-copper overlay can cover a majority of the copper material. The non-copper overlay may leave a portion of the copper material uncovered. The copper material may be not visible on the human visibility spectrum. The copper material can include a copper alloy. The copper material overlays a substrate not including copper material. The copper material can be removably attached to a substrate.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject invention appertains will readily understand how to make and use the devices and methods of the subject invention without undue experimentation, preferred embodiments thereof will be described in detail herein below with reference to certain FIGURES, wherein:

FIG. 1 is a perspective view of a galley of an aircraft according to an embodiment of the invention.

### DETAILED DESCRIPTION

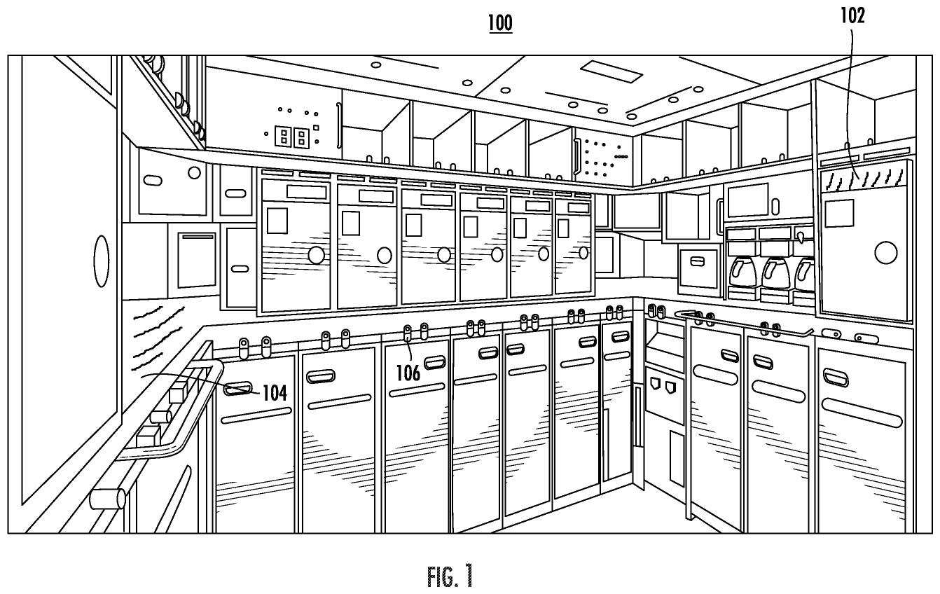

Reference will now be made to the drawings wherein like reference numerals identify similar structural features or aspects of the subject invention. For purposes of explanation and illustration, and not limitation, a partial view of an exemplary embodiment of a galley of an aircraft in accordance with the invention is shown in FIG. 1 and is designated generally by reference character 100. The methods and systems of the invention can be used to decrease viral and bacterial transmission rates by touch surfaces in an aircraft setting.

FIG. 1 shows the interior of an aircraft cabin galley 100 having a plurality of touch surfaces 102, 104, 106. A touch surface can include anything that requires to be touched by a crew member or passenger to be activated or used. A touch surface can include a handle, a counter-top, a door handle, a touch screen interface, a button. Multiple places on an aircraft require contact in a very particular spot, ensuring that if two people touch the item, the contact will be in the same space. In order to reduce the probability of viral and bacterial transmission at that location. The copper material overlays a substrate that does not including copper material. The copper material can be removably attached to a substrate.

FIG. 1 further shows that at least one of the touch surfaces includes a copper material wherein the copper material portion is user facing and accessible to a user. At least one of the touch surfaces can be connected to a touch-screen interface 102. The user-facing portion of the touch screen interface can be copper plated. The copper plating can be thin enough that it is transparent, thus allowing the touch screen interface to still be viewed and used.

The touch surface can include a counter top 104 or drawer handle 106. It is conceived that a majority of the touch surfaces within the galley can be copper plated. Some touch surfaces are not able to include copper for electrical transmission purposes, thus some touch surfaces within the galley remain without a copper plating. Some of the touch surfaces can be partially covered with a copper material.

In order provide further antibacterial protection or to improve visibility of the copper material to a user, in order for the users to target the copper surfaces or portions of surfaces the copper can include a non-copper overlay or coating. The non-copper overlay wherein the non-copper overlay is opaque and is non-copper colored. The coating allows the copper antibacterial and anti-viral properties to still permeate and render the copper useful, while also enhancing the look, feel, and visibility of the copper surfaces. The non-copper overlay can include a color that includes a wavelength visible to the human eye. The non-copper overlay can cover a majority of the copper material but leave a portion of the copper material uncovered.

The methods and systems of the present disclosure, as described above and shown in the drawings, provide for a galley system providing better protection from viral and bacterial spread. While the apparatus and methods of the subject disclosure have been showing and described with reference to embodiments, those skilled in the art will readily appreciate that changes and/or modifications may be made thereto without departing from the spirit and score of the subject disclosure.

What is claimed is:

1. An aircraft, comprising:
a cabin galley having a plurality of touch surfaces;
wherein at least one of the touch surfaces includes a copper material.

2. The aircraft of claim 1, wherein the at least one the touch surfaces includes a user facing surface.

3. The aircraft of claim 1, wherein the at least one touch surface is connected to a touch-screen interface.

4. The aircraft of claim 3, wherein the touch screen interface is copper plated.

5. The aircraft of claim 4, wherein the copper plating is transparent.

6. The aircraft of claim 1, wherein the touch surface includes a counter top.

7. The aircraft of claim 1, wherein the touch surface includes a drawer handle.

8. The aircraft of claim 1, wherein a majority of the touch surface is copper plated.

9. The aircraft of claim 1, wherein a portion of the touch surface does not include copper.

10. The aircraft of claim 1, wherein a majority of the touch surfaces of the cabin galley include a copper material.

11. The aircraft of claim 1, wherein a majority of handles within the galley include a copper surface.

12. The aircraft of claim 1, wherein the copper material includes a non-copper overlay.

13. The aircraft of claim 12, wherein the non-copper overlay is opaque.

14. The aircraft of claim 12, wherein the non-copper overlay includes a non-copper color.

15. The aircraft of claim 12, wherein the non-copper overlay covers a majority of the copper material.

16. The aircraft of claim 12, wherein the non-copper overlay does not cover a portion of the copper material.

17. The aircraft of claim 1, wherein the copper material is not visible on the human visibility spectrum.

18. The aircraft of claim 1, wherein the copper material includes a copper alloy.

19. The aircraft of claim 1, wherein the copper material overlays a substrate not including copper material.

20. The aircraft of claim 1, wherein the copper material is removable attached to a substrate.
